(19) United States
(12) Patent Application Publication
(10) Pub. No.: US 2016/0118900 A1
(43) Pub. Date: Apr. 28, 2016

(54) POWER SUPPLY ADAPTOR

(71) Applicant: ROHM CO., LTD., Tokyo (JP)

(72) Inventors: Satoru Nate, Ukyo-ku (JP); Tadayuki Sakamoto, Ukyo-ku (JP); Hiroshi Hayashi, Ukyo-ku (JP)

(21) Appl. No.: 14/984,441

(22) Filed: Dec. 30, 2015

Related U.S. Application Data
(62) Division of application No. 13/511,778, filed on May 24, 2012, now abandoned.

(30) Foreign Application Priority Data
Nov. 25, 2009 (JP) 2009-268130
Jan. 27, 2010 (JP) 2010-015665

(51) Int. Cl. H02M 3/335

(52) U.S. Cl. CPC H02M 3/33507; H02M 2001/0032

(57) ABSTRACT

A power supply adapter receives an AC voltage, converts the AC voltage into a DC voltage, and supplies the DC voltage to an electronic device. A DC/DC converter converts the voltage smoothed by a smoothing capacitor into the DC voltage. A device-side connector is connected to the DC/DC converter via a cable, and is configured to be detachably connected to the electronic device. The device-side connector includes a detection unit detecting whether or not the electronic device is connected, and generates a connection detection signal indicating whether or not the electronic device is connected. A control circuit of the DC/DC converter is connected to the detection unit of the device-side connector via the cable, and is set to an operating state when the connection detection signal indicates that the electronic device is connected, and is set to a non-operating state when the connection detection signal indicates that the electronic device is not connected.

### CROSS REFERENCE TO RELATED APPLICATIONS

The present application is a divisional application of U.S. patent application Ser. No. 13/511,778, filed on May 24, 2012, the entire contents of which are incorporated herein by reference and priority to which is hereby claimed. Application Ser. No. 13/511,778 is the U.S. National stage of application No. PCT/JP2010/006890, filed on 25 Nov. 2010. Priority under U.S.C. §119(a) and 35 U.S.C. §365(b) is claimed from Japanese Application No. 2009-268130, filed 25 Nov. 2009, and Japanese Application No. 2010-015665, filed 27 Jan. 2010, the disclosure of which are also incorporated herein by reference.

### BACKGROUND OF THE INVENTION

1. Field of the Invention

The present invention relates to a control technique for a DC/DC converter.

2. Description of the Related Art

Electronic devices such as laptop computers, cellular phone terminals, or PDAs (Personal Digital Assistants), are configured to operate receiving electric power from an external power supply, in addition to operating receiving electric power from a built-in battery. Furthermore, such electronic devices are configured to be capable of charging such a built-in battery using electric power from such an external power supply.

As an external power supply configured to supply electric power to such an electronic device, a power supply adapter (AC adapter) configured to perform AC/DC conversion of commercial AC voltage is employed. FIG. 1 is a diagram which shows a configuration of a power supply adapter. A power supply adapter 200 includes a plug configured to receive an AC voltage Vac, a device-side connector 206, a diode bridge circuit 208, a smoothing capacitor C1, and a DC/DC converter 210.

The plug 202 receives the commercial AC voltage Vac in a state in which it is plugged into a receptacle 201 of an electrical outlet for wiring connection use. The diode bridge circuit 208 performs full-wave rectification of the AC voltage Vac. The smoothing capacitor C1 smoothes the voltage rectified by the diode bridge circuit 208. The DC/DC converter 210 converts the voltage level of the DC voltage thus smoothed. The DC voltage Vdc thus stabilized to a given voltage level by the DC/DC converter 210 is supplied to the electronic device 1 via the device-side connector 206. The diode bridge circuit 208, the smoothing capacitor C1, and the DC/DC converter 210 are included in a casing 204 as built-in components. The casing 204 and the plug 202 are connected via a cable. Furthermore, the casing 204 and the device-side connector 206 are connected via a cable.

### RELATED ART DOCUMENTS

### Patent Documents

### [Patent Document 1]

Japanese Patent Application Laid Open No. H09-098571

### [Patent Document 2]

Japanese Patent Application Laid Open No. H02-211055

1. With conventional power supply adapters, in a state in which the plug 202 is plugged into the receptacle 201, the DC/DC converter 210 always operates so as to generate the DC voltage Vdc. This leads to wasted power consumption (standby power consumption).

2. FIG. 5 is a diagram which shows a configuration of a power supply adapter as investigated by the present inventor. It should be noted that the specific configuration of the power supply adapter 200 should not be regarded as a typical technique well known by those skilled in this art.

The power supply adapter 200 includes a plug 202 configured to receive AC voltage Vac, a diode bridge circuit 208, an input capacitor C1, and a DC/DC converter 210.

The plug 202 receives the commercial AC voltage Vac in a state in which it is plugged into the receptacle 201 of an electrical outlet for wiring connection use. The diode bridge circuit 208 performs full-wave rectification of the AC voltage Vac. The input capacitor C1 smoothes the voltage thus rectified by the diode bridge circuit 208. The DC/DC converter 210 converts the level of the DC voltage thus smoothed. The DC voltage Vout thus stabilized by the DC/DC converter 210 to a given voltage level is supplied to the electronic device. The diode bridge circuit 208, the input capacitor C1, and the DC/DC converter 210 are each included within a casing 204 as built-in components.

The present inventors have investigated such a power supply adapter 200, and have come to recognize the following problem.

The DC/DC converter 210 mainly includes a switching transistor M1, a transformer T1, a first diode D1, a first output capacitor Co1, a control circuit 212, and a feedback circuit 214. With such a power supply adapter 200, a primary side and a secondary side of the transformer T1 must be electrically isolated from one another. The feedback circuit 214 is configured as a so-called photo-coupler, and is configured to feed back a feedback signal that represents the output voltage Vout to the control circuit 212. The control circuit 212 controls the duty ratio of the on/off operation of the switching transistor M1 by means of pulse modulation such that the output voltage Vout matches a target value.

The control circuit 212 can be configured to operate using a power supply voltage Vcc on the order of 10 V. However, if the control circuit 212 is driven using a voltage (on the order of 140 V) smoothed by the input capacitor C1, the operating efficiency of the control circuit 212 becomes poor. The voltage stepped down by the DC/DC converter 210 is generated on the secondary side of the transformer T2. Accordingly, the voltage Vout thus stepped down cannot be supplied to the control circuit 212 arranged on the primary side.

In order to solve such a problem, an auxiliary coil L3 is provided on the primary side of the transformer T1. The auxiliary coil L3, a second diode D2, and a second output capacitor Co2 function as an auxiliary DC/DC converter configured to generate the power supply voltage Vcc for the control circuit 212.

At one terminal N3 of the auxiliary coil L3, a pulse voltage VD is generated, which is synchronized to the on/off operation of the switching transistor M1. When the switching transistor M1 is on, the pulse voltage VD becomes the ground voltage (0 V). Immediately after the switching transistor M1 is switched from the on state to the off state, the pulse voltage VD rises to a high voltage, which is on the order of several tens of V.

If the output capacitor Co2 has a sufficiently large capacitance, the output capacitor Co2 is capable of relaxing the effects of the voltage jump at the one terminal N3 of the auxiliary coil L3, thereby providing an output voltage Vcc that is stable to a certain extent. However, in a case in which the second output capacitor Co2 has a large capacitance, the rising rate of the power supply voltage Vcc becomes slow. Thus, the second output capacitor Co2 cannot be configured to have a sufficiently large capacitance.

With the second output capacitor Co2 configured to have a realistic capacitance, the power supply voltage Vcc rises up to several tens of V (e.g., on the order of 30 V) due to the effects of the jump in the voltage VD generated at the one terminal N3 of the auxiliary coil L3, which has an adverse effect on the control circuit 212. Specifically, in some cases, this leads to the control circuit 212 performing an overvoltage protection operation (OVP), and leads to a situation in which the power supply voltage Vcc exceeds the breakdown voltage of the control circuit 212.

The jump in the voltage VD at the terminal N3 is due to magnetic flux leakage from the transformer T1 or the like. Accordingly, the jump in the voltage VD can be reduced by accurately designing the transformer T1. However, such an approach leads to another problem in that the cost of the transformer T1 becomes high.

### SUMMARY OF THE INVENTION

1. An embodiment of the present invention has been made in order to solve such a problem. Accordingly, it is an exemplary purpose of the present invention to provide a power supply having reduced power consumption.

2. Another embodiment of the present invention has been made in order to solve such a problem. Accordingly, it is an exemplary purpose of the present invention to provide a power supply circuit which is capable of suppressing fluctuation in the power supply voltage to be supplied to a control circuit.

1. An embodiment of the present invention relates to a power supply adapter configured to receive an AC voltage, to convert the AC voltage thus received into a DC voltage, and to supply the DC voltage thus converted to an electronic device. The power supply adapter comprises: a plug configured to receive the AC voltage in a state in which it is plugged into a receptacle; a rectifier circuit configured to rectify the AC voltage supplied via the plug; a smoothing capacitor configured to smooth the voltage rectified by the rectifier circuit; a DC/DC converter configured to receive the voltage smoothed by the smoothing capacitor, and to convert the voltage thus received into a DC voltage having a level to be supplied to the electronic device; a device-side connector configured to be connected to the DC/DC converter via a cable, to be detachably connected to the electronic device, and to supply the DC voltage to the electronic device in a state in which it is connected to the electronic device. The device-side connector comprises a detection unit configured to detect whether or not the electronic device is connected to the device-side connector, and to generate a connection detection signal which indicates whether or not the electronic device is connected to the device-side connector. The DC/DC converter comprises a control circuit configured to be connected to the detection unit of the device-side connector via the cable, to be set to an operating state when the connection detection signal indicates that the electronic device is connected, and to be set to a non-operating state when the connection detection signal indicates that the electronic device is not connected.

With such an embodiment, the control circuit of the DC/DC converter is operated when the device-side connector is plugged into a connector receptacle of the electronic device and the connection of the electronic device is detected, and when the connection of the electronic device is not detected, the control circuit of the DC/DC converter can be switched to the non-operating state (standby state). Thus, such an arrangement provides reduced power consumption in the standby state.

Also, the electronic device may comprise: an internal battery configured to be charged by the DC voltage; and a signal processing unit configured to generate a full charge detection signal indicating whether or not the internal battery is in a full charge state. Also, the full charge detection signal may be input to the control circuit of the DC/DC converter via the cable in a state in which the electronic device is connected to the device-side connector. Also, when the full charge detection signal indicates that the internal battery is in the full charge state, the control circuit may be set to the non-operating state.

When the internal battery on the electronic device side is in the full charge state, the electronic device can operate using electric power received from the internal battery. Accordingly, there is no need to supply electric power from an external power supply adapter. Thus, in such a case, the control circuit is set to the standby state, thereby reducing the standby electric power required by the power supply adapter.

Also, the detection unit may be configured to detect a mechanical connection between the device-side connector and the electronic device. Also, the detection unit may be configured to detect an electrical connection between the device-side connector and the electronic device.

Another embodiment of the present invention relates to a control circuit of a DC/DC converter. The DC/DC converter is included as a built-in component in a power supply adapter configured to receive an AC voltage, to convert the AC voltage thus received into a DC voltage, and to supply the DC voltage thus converted to an electronic device. The power supply adapter comprises a device-side connector. The device-side connector is configured to be connected to the DC/DC converter via a cable, and to be detachably connected to the electronic device, and to supply the DC voltage to the electronic device via the device-side connector in a state in which it is connected to the electronic device. The device-side connector comprises a detection unit configured to detect whether or not the electronic device is connected, and to generate a connection detection signal which indicates whether or not the electronic device is connected.

The control circuit comprises: an enable terminal configured to receive the connection detection signal from the device-side connector; and a control unit configured to be set to an operating state in which the output voltage of the DC/DC converter is stabilized by means of a feedback operation when the connection detection signal indicates that the electronic device is connected. Furthermore, the control unit is configured to be set to a non-operating state in which the control operation of the DC/DC converter is stopped when the connection detection signal indicates that no electronic device is connected.

Such an embodiment is capable of reducing power consumption of the power supply adapter when no electric device is connected.

Also, the electronic device may comprise: an internal battery configured to be charged by the DC voltage; and a signal processing unit configured to generate a full charge detection signal whether or not the internal battery is in a full charge state. The control circuit may further comprise a second enable terminal configured to receive the full charge detection signal. When the full charge detection signal indicates that the internal battery is in the full charge state, the control unit may be set to the non-operating state.

Yet another embodiment of the present invention relates to a device-side connector configured to be detachably connected to an electronic device having a power supply terminal configured to receive a DC voltage. The device-side connector comprises a power source terminal and a detection unit. The power source terminal is configured to receive a DC voltage via a cable from a DC/DC converter included in the power supply adapter, and is arranged such that the power source terminal faces and is connected to the power supply terminal in a state in which the device-side connector is connected to the electronic device. The detection unit is configured to detect whether or not the electronic device is connected to the device-side connector, and to generate a connection detection signal which indicates whether or not the electronic device is connected. The device-side connector is configured such that the connection detection signal is supplied to a control circuit of the DC/DC converter via the cable.

With such an embodiment, the control circuit of the DC/DC converter included as a built-in component in the power supply adapter can be switched to the non-operating state when no electronic device is connected to the device-side connector. Thus, such an arrangement provides reduced power consumption.

Also, the electronic device may comprise: an internal battery configured to be charged by the DC voltage; a signal processing unit configured to generate a full charge detection signal whether or not the internal battery is in a full charge state; and a detection terminal configured to output the full charge detection signal to an external circuit. Also, the device-side connector may further comprise a detection signal receiving terminal arranged such that it faces and is connected to the detection terminal in a state in which the device-side connector is connected to the electronic device, and configured to receive the full charge detection signal from the signal processing unit. Also, the device-side connector may be configured such that the full charge detection signal is supplied via a cable to a control circuit of the DC/DC converter.

Yet another embodiment of the present invention relates to an electronic device configured to operate receiving an AC voltage, and to be switchable between a normal operating mode and a standby mode. The electronic device comprises: a plug configured to receive the AC voltage in a state in which it is plugged into a receptacle; a rectifier circuit configured to rectify the AC voltage supplied via the plug; a smoothing capacitor configured to smooth the voltage rectified by the rectifier circuit; a DC/DC converter configured to receive the voltage smoothed by the smoothing capacitor, and to convert the voltage thus smoothed into a DC voltage having a predetermined level; a control circuit configured to receive the smoothed voltage via a power supply terminal thereof, to control the DC/DC converter such that the output voltage of the DC/DC converter is maintained at a constant level, and to be switchable between an operating state and a non-operating state according to a control signal input to an enable terminal thereof; an activation switch configured to receive an instruction to switch the mode of the electronic device from the standby mode to the normal operating mode; a standby switch configured to receive an instruction to switch the mode of the electronic device from the normal operating mode to the standby mode; and a signal processing unit configured to receive the output voltage of the DC/DC converter via a power supply terminal thereof, to perform predetermined signal processing when the electronic device is in the normal operating mode, to monitor the standby switch, and to output, to the enable terminal of the control circuit, a control signal which indicates whether or not the electronic device is in the normal operating mode or in the standby mode.

With such an embodiment, the control circuit of the DC/DC converter in the standby mode is set to the non-operating state, thereby providing reduced power consumption of the power supply component of the electronic device.

Also, the control circuit may comprise: a reference voltage circuit configured to generate a predetermined reference voltage; and a reference voltage terminal configured to output the reference voltage to an external circuit. Also, together with the output voltage of the DC/DC converter, the reference voltage may be supplied to the power supply terminal of the signal processing unit.

With such an embodiment, in the standby mode, the reference voltage is supplied to the power supply terminal of the signal processing unit, instead of the DC voltage. Thus, such an arrangement allows the signal processing unit to perform necessary minimum signal processing even in the standby mode.

An embodiment of the present invention relates to a DC/DC converter. The DC/DC converter comprises: a transformer comprising a primary coil, a secondary coil, and an auxiliary coil arranged on the primary coil side; a first output capacitor arranged such that one terminal thereof is set to a fixed electric potential; a first diode arranged between the other terminal of the first output capacitor and one terminal of the secondary coil such that the cathode thereof is on the first output capacitor side; a switching transistor arranged on a path of the first primary coil; a second output capacitor arranged such that one terminal thereof is set to a fixed electric potential; a second diode and a mask switch arranged in series between the other terminal of the second output capacitor and one terminal of the auxiliary coil switch such that the cathode of the second diode is on the second output capacitor side; and a control circuit configured to receive, via a power supply terminal thereof, a voltage that develops at the second output capacitor, and to control an on/off operation of the switching transistor.

With such an embodiment, by turning off the mask switch, such an arrangement is capable of preventing the jump in the voltage that occurs at the auxiliary coil from having an effect on the voltage that develops at the second output capacitor.

Also, the mask switch may be turned off during a mask period, which is a period that begins when the switching transistor switches to the off state, and which continues until a predetermined period of time elapses.

Also, the mask switch may be turned off during a period in which the switching transistor is turned off, in addition to the mask period.

Also, the control circuit may comprise a terminal configured to output a mask signal that is used to control the mask switch.

Also, the control circuit may be configured to generate the mask signal by delaying a control signal that is supplied to the switching transistor.

Also, the power supply apparatus according to an embodiment may further comprise a feedback circuit configured to generate a feedback signal that corresponds to a voltage that develops at the first output capacitor. Also, the control circuit may be configured to adjust the on/off duty ratio of the switching transistor such that the feedback signal approaches a target value.

Also, in the power supply apparatus according to an embodiment, the control circuit may be configured to adjust the on/off duty ratio of the switching transistor such that a feedback signal that corresponds to a voltage that develops at the second output capacitor approaches a target value. With such an arrangement, there is no need to feedback the voltage that develops at the first output capacitor to the control circuit. Thus, such an arrangement does not require a feedback circuit such as a photo-coupler or the like.

Also, the mask switch may comprise a P-channel MOSFET (Metal Oxide Semiconductor Field Effect Transistor) or a PNP bipolar transistor.

Also, the control circuit may comprise: an error amplifier configured to amplify the difference between the feedback signal and the target value thereof; a first comparator configured to generate an off signal which is asserted when the current that flows through the switching transistor reaches a level that corresponds to the output signal of the error amplifier; a second comparator configured to generate an on signal which is asserted when the electric potential at a node between the second diode and the auxiliary coil drops to a predetermined level; a flip-flop configured to switch the state thereof according to the on signal and the off signal; a driver configured to drive the switching transistor according to the output signal of the flip-flop; and a mask signal generating unit configured to generate a mask signal based upon the output signal of the flip-flop.

Another embodiment of the present invention relates to a power supply apparatus configured to receive an AC voltage, to convert the AC voltage thus received into a DC voltage, and to supply the DC voltage thus converted to an electronic device. The power supply apparatus comprises: a rectifier circuit configured to rectify the AC voltage; an input capacitor configured to smooth the voltage rectified by the rectifier circuit; and a DC/DC converter according to any one of the aforementioned embodiments, configured to convert the voltage smoothed by the input capacitor.

It should be noted that any combination of the aforementioned components may be made, and any component of the present invention or any manifestation thereof may be mutually substituted between a method, an apparatus, a system, and so forth, which are effective as an embodiment of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows a configuration of a typical power supply adapter;

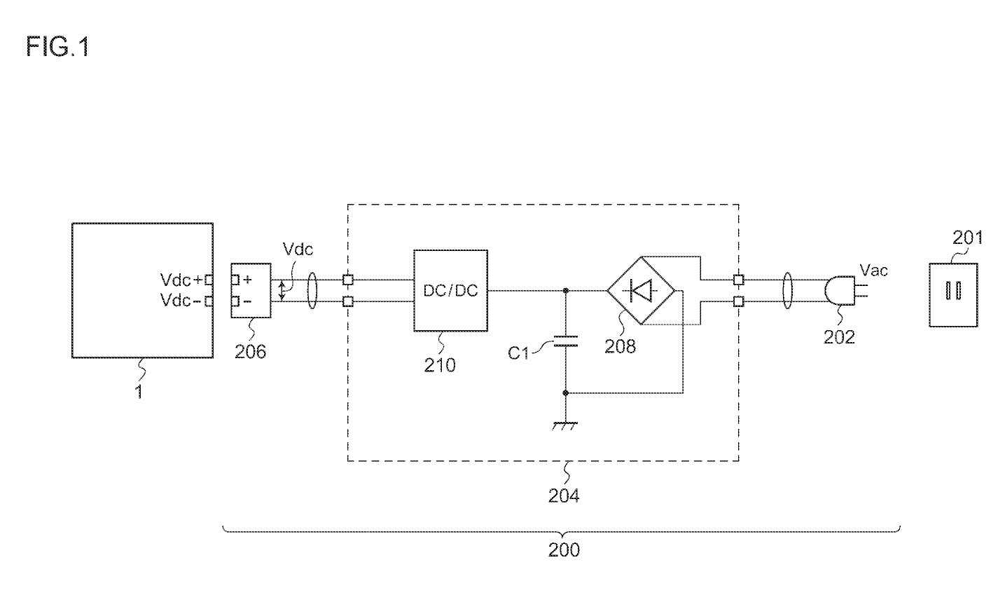

FIG. 2 is a diagram which shows a configuration of a power supply adapter according to a first embodiment;

FIG. 3 is a diagram which shows a configuration of a modification of the power supply adapter shown in FIG. 2;

FIG. 4 is a diagram which shows a configuration of an electronic device according to a second embodiment;

FIG. 5 is a diagram which shows a configuration of a power supply adapter as investigated by the present inventor;

FIG. 6 is a circuit diagram which shows a configuration of a power supply apparatus according to a third embodiment;

FIG. 7 is a circuit diagram which shows an example configuration of a control circuit shown in FIG. 6;

FIG. 8 is a time chart which shows the operation of the power supply apparatus shown in FIG. 6; and

FIG. 9 is a circuit diagram which shows a configuration of a power supply apparatus according to a modification.

### DETAILED DESCRIPTION OF THE INVENTION

Description will be made below regarding preferred embodiments according to the present invention with reference to the drawings. The same or similar components, members, and processes are denoted by the same reference numerals, and redundant description thereof will be omitted as appropriate. The embodiments have been described for exemplary purposes only, and are by no means intended to restrict the present invention. Also, it is not necessarily essential for the present invention that all the features or a combination thereof be provided as described in the embodiments.

In the present specification, a state represented by the phrase the member A is connected to the member B″ includes a state in which the member A is indirectly connected to the member B via another member that does not affect the electric connection therebetween, in addition to a state in which the member A is physically and directly connected to the member B.

Similarly, a state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

### First Embodiment

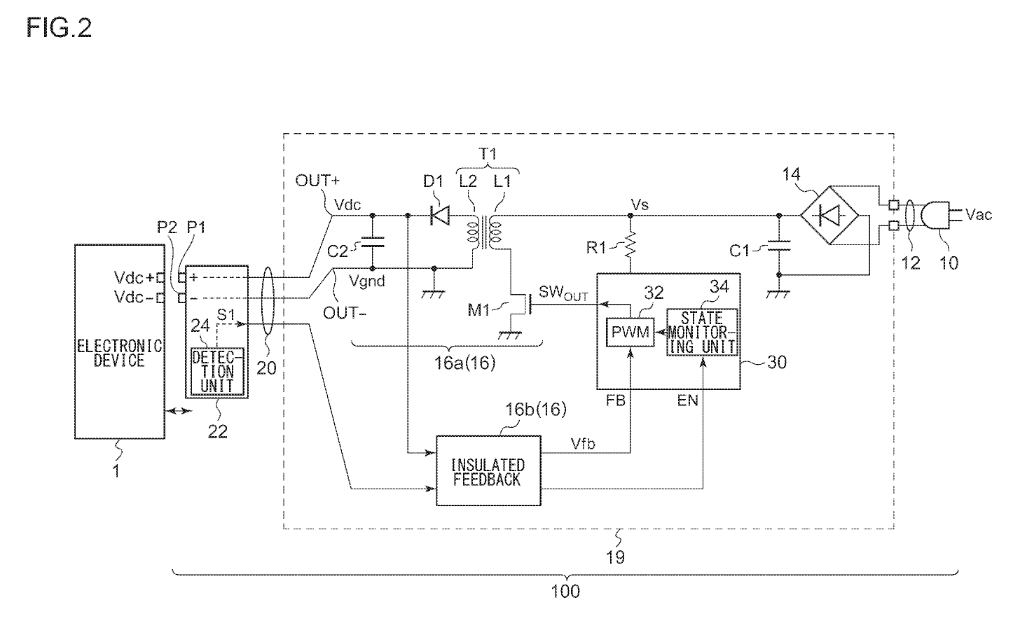

FIG. 2 is a diagram which shows a configuration of a power supply adapter 100 according to a first embodiment. The power supply adapter 100 receives an AC voltage Vac such as commercial AC voltage, converts the AC voltage Vac thus received into a DC voltage Vdc, and supplies the DC voltage Vdc thus converted to an electronic device 1. Examples of such an electronic device 1 include a laptop computer, a desktop computer, a cellular phone terminal, a CD player, etc. However, the electronic device 1 is not restricted in particular.

The power supply adapter 100 includes a plug 10, a plug cable 12, a rectifier circuit 14, a smoothing capacitor C1, a resistor R1, a DC/DC converter 16, a control IC 30, a connector-side cable 20, and a device-side connector 22.

The rectifier circuit 14, the smoothing capacitor C1, the DC/DC converter 16, and the control IC 30 are included within the same casing 19. The connection between the plug 10 and the casing 19 is provided by the plug cable 12. Furthermore, the connection between the device-side connector 22 and the casing 19 is provided by the connector-side cable 20.

The plug 10 is configured as a socket configured to engage with a receptacle, and is configured to receive the AC voltage Vac in the state in which it is plugged into a receptacle. The rectifier circuit 14 performs full-wave rectification of the AC voltage Vac supplied via the plug 10 and the plug cable 12. The rectifier circuit 14 is configured as a diode bridge circuit, for example. The smoothing capacitor C1 smoothes the voltage rectified by the rectifier circuit 14.

The DC/DC converter 16 receives the voltage smoothed by the smoothing capacitor C1, and converts the voltage thus received into a DC voltage Vdc having a level to be supplied to the electronic device 1. The DC/DC converter 16 includes a converter unit 16a and a feedback unit 16b. The topology of the converter unit 16a is not restricted in particular. FIG. 2 shows a converter employing a transformer T1. The converter unit 16a includes: the transformer T1 including a primary coil L1 and a secondary coil L2; a switching transistor M1 arranged on a path of the primary coil L1; a rectifier diode D1 connected to the secondary coil L2; and an output capacitor C2 connected to the cathode side of the rectifier diode D1.

The feedback unit 16b is configured as an isolated feedback circuit configured such that the primary side thereof is electrically insulated from the secondary side thereof. The feedback unit 16b is configured using a photo-coupler, for example. The feedback unit 16b feeds back the output voltage Vdc of the DC/DC converter 16 to the control IC 30, and transmits a connection detection signal S1 generated by the device-side connector 22, which will be described later, to the control IC 30. It should be noted that the feedback unit 16b may be configured as a non-isolated circuit.

The control IC 30 includes a feedback terminal FB, a switching signal generating unit 32, and a state monitoring unit 34. The switching signal generating unit 32 generates a switching signal SWOUT according to a feedback signal Vfb input to the feedback terminal FB, so as to perform switching of the switching transistor M1. The switching transistor M1 may be configured as a built-in component included in the control IC 30. The control IC 30 controls the duty ratio of the switching signal SWOUT, i.e., the on period and the off period of the switching transistor M1 (PWM: Pulse Width Modulation), or otherwise controls the frequency of the switching signal SWOUT (PFM: Pulse Frequency Modulation), such that the feedback signal Vfb is maintained at a constant level, i.e., such that the DC voltage Vdc is maintained at a constant level.

The device-side connector 22 is connected to the DC/DC converter 16 via the connector-side cable 20. Furthermore, the device-side connector 22 is configured so as to be detachably and directly or indirectly connected to the electronic device 1. That the device-side connector 22 is detachably and directly connected to the electronic device 1 means that the device-side connector 22 is directly plugged into or is directly put in contact with a socket or a plug provided to the electronic device 1. Furthermore, that the device-side connector 22 is detachably and indirectly connected to the electronic device 1 means that they are connected via an extension cable or the like.

The DC voltage Vdc generated by the DC/DC converter 16 and the ground electric potential Vgnd are output to the device-side connector 22 via the connector-side cable 20. The electronic device 1 includes a power supply terminal Vdc+ configured to receive the DC voltage Vdc from the power supply adapter 100 and a power supply terminal Vdc− configured to receive the ground voltage Vgnd. The device-side connector 22 includes voltage supply terminals P1 and P2 configured such that they respectively face and are connected to the power supply terminals Vdc+ and Vdc− in a state in which the device-side connector 22 is connected to the electronic device 1. The voltage supply terminals P1 and P2 are respectively connected to a positive output terminal OUT+ and a negative output terminal OUT− of the DC/DC converter 16 via a cable 20.

The device-side connector 22 includes a detection unit 24. The detection unit 24 detects whether or not the electronic device 1 is connected to the device-side connector 22. With such an arrangement, the detection unit 24 generates a connection detection signal S1 which represents whether or not the electronic device 1 is connected. For example, when the electronic device 1 is connected, the connection detection signal S1 is set to high level (asserted), and when the electronic device 1 is not connected, the connection detection signal S1 is set to low level (negated). The signal format of the connection detection signal S1 is not restricted in particular.

The detection unit 24 may detect whether or not the device-side connector 22 is connected to the electronic device 1 using a mechanical mechanism. Alternatively, the detection unit 24 may detect whether or not the device-side connector 22 is connected to the electronic device 1, using electrical signal processing such as voltage detection, current detection, impedance detection, or the like.

The connection detection signal S1 is input to the enable terminal EN of the control IC 30 via the connector-side cable 20 and the feedback unit 16b.

The control IC 30 is configured to be switchable between the operating state and the non-operating state (standby state). In the operating state, the switching signal generating unit 32 controls the switching transistor M1 based on the feedback signal Vfb. On the other hand, in the standby state, the switching signal generating unit 32 stops the operation of circuit blocks other than the minimum necessary circuit blocks such that the power consumption thereof becomes substantially zero. By stopping the operation of all the unnecessary circuit blocks, such an arrangement is capable of suppressing their power consumption to 50 mW or less. It can be said that such an arrangement provides substantially zero power consumption.

The state monitoring unit 34 switches the switching signal generating unit 32 (control IC 30) between the operating state and the non-operating state according to the connection detection signal S1 input to the enable terminal EN. Specifically, when the connection detection signal S1 indicates that the electronic device 1 is connected, the control IC 30 is set to the operating state. Conversely, when the connection detection signal S1 indicates that the electronic device 1 is not connected, the control IC 30 is set to the standby state.

The above is the configuration of the power supply adapter 100. Next, description will be made regarding the operation thereof.

(a) When the user plugs the plug 10 into a receptacle, the AC voltage Vac is supplied to the power supply adapter 100. In this state, let us say that the electronic device 1 is not connected to the device-side connector 22. In this state, the control IC 30 receives, as an input signal, the connection detection signal S1, which indicates that the electronic device 1 is not connected. As a result, the control IC 30 transits to the standby state, and thus, the power consumption of the power supply adapter 100 becomes very small.

(b) Next, when the electronic device 1 is connected to the device-side connector 22, the connection detection signal S1 is asserted, which notifies the control IC 30 of the connection of the electronic device 1. Upon receiving this notice, the state monitoring unit 34 switches the switching signal generating unit 32 from the standby state to the operating state. As a result, the DC/DC converter 16 generates a DC voltage Vdc, and supplies the DC voltage Vdc thus generated to the electronic device 1.

(c) Next, when the device-side connector 22 is disconnected from the electronic device 1, the device-side connector 22 negates the connection detection signal S1. As a result, the state monitoring unit 34 switches the switching signal generating unit 32 to the standby state, which reduces the power consumption.

(d) Moreover, when the plug 10 is plugged into a receptacle in the state in which the device-side connector 22 is connected to the electronic device 1 in the first stage, the switching signal generating unit 32 immediately switches to the operating state in which the DC voltage Vdc is supplied to the electronic device 1.

As described above, with the power supply adapter 100 shown in FIG. 2, the device-side connector 22 is provided with a mechanism for detecting whether or not the electronic device 1 is connected. This allows the control IC 30 to be switched between the operating state and the non-operating state according to the detection result. Thus, such an arrangement reduces unnecessary power consumption.

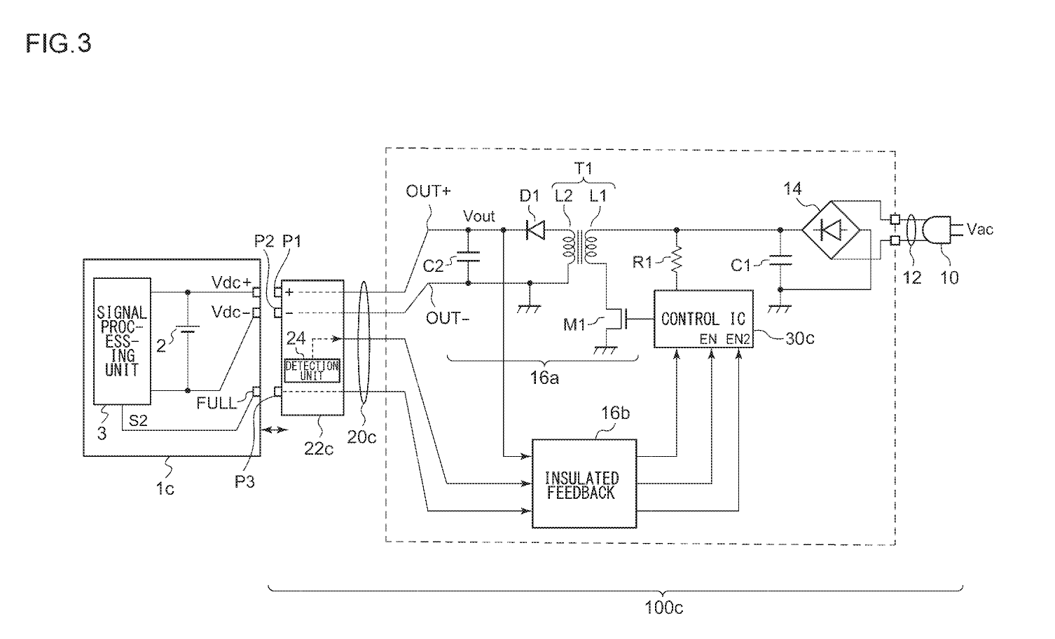

FIG. 3 is a diagram which shows a configuration of a power supply adapter 100c according to a modification of the power supply adapter 100 shown in FIG. 2. Description will be made below regarding the configuration of the power supply adapter 100c, focusing on how it differs from the configuration of the power supply adapter 100 shown in FIG. 2.

The electronic device 1c includes an internal battery 2 and a signal processing unit 3. The internal battery 2 is configured to be charged by the DC voltage Vdc received from the power supply adapter 100c. The signal processing unit 3 is configured as a microcomputer, for example, and is configured to generate a full charge detection signal S2 which indicates whether or not the internal battery 2 is in the full charge state. The electronic device 1c includes a detection terminal FULL configured to output the full charge detection signal S2 to a device-side connector 22c.

The device-side connector 22c includes a detection signal reception terminal P3, in addition to the voltage supply terminals P1 and P2. The detection signal reception terminal P3 is arranged such that, in a state in which the device-side connector 22c is connected to the electronic device 1, it faces the detection terminal FULL and is connected to the detection terminal FULL. The detection signal reception terminal P3 receives the full charge detection signal S2 from the signal processing unit 3. The detection signal reception terminal P3 is connected to a control IC 30c via a cable 20c, which allows the full charge detection signal S2 to be supplied to the control IC 30c.

The control IC 30c further includes a second enable terminal EN2 configured to receive the full charge detection signal S2. The internal configuration of the control IC 30c is configured in the same way as the control IC 30 shown in FIG. 2. The state monitoring unit 34 monitors the full charge detection signal S2, in addition to monitoring the connection detection signal S1. When the full charge detection signal S2 indicates that the internal battery 2 is in the full charge state, the switching signal generating unit 32 is set to the standby state.

In general, in a case in which the internal battery on the electronic device side is in the full charge state, the electronic device can operate using the electric power from the internal battery. Thus, there is no need to supply electric power from an external power supply adapter. With the power supply adapter 100c shown in FIG. 3, such an arrangement is capable of setting the control IC 30c to the standby state if the internal battery 2 is in the full charge state. Thus, such an arrangement is capable of reducing the standby power consumption of the power supply adapter 100c to substantially zero.

### Second Embodiment

Description has been made in the first embodiment regarding a technique for reducing the power consumption of the power supply adapter. In contrast, description will be made in the second embodiment regarding a technique for reducing the power consumption of an electronic device including a built-in power supply circuit.

In general, consumer electronics devices (electrical appliances) such as washing machines, air conditioners, TVs, etc., operate receiving an AC voltage Vac. In many cases, such consumer electronics devices are configured to be switched between a mode in which they provide their primary function (which will be referred to as the “normal operating mode”) and a mode in which they perform an operation that differs from their primary function (which will be referred to as the “standby mode”). For example, with a washing machine, the normal operating mode corresponds to a period in which washing or drying is performed, and the standby mode corresponds to a period in which the washing machine is in a standby state using a program timer. The technique described below can be used to reduce the power consumption of such consumer electronics devices.

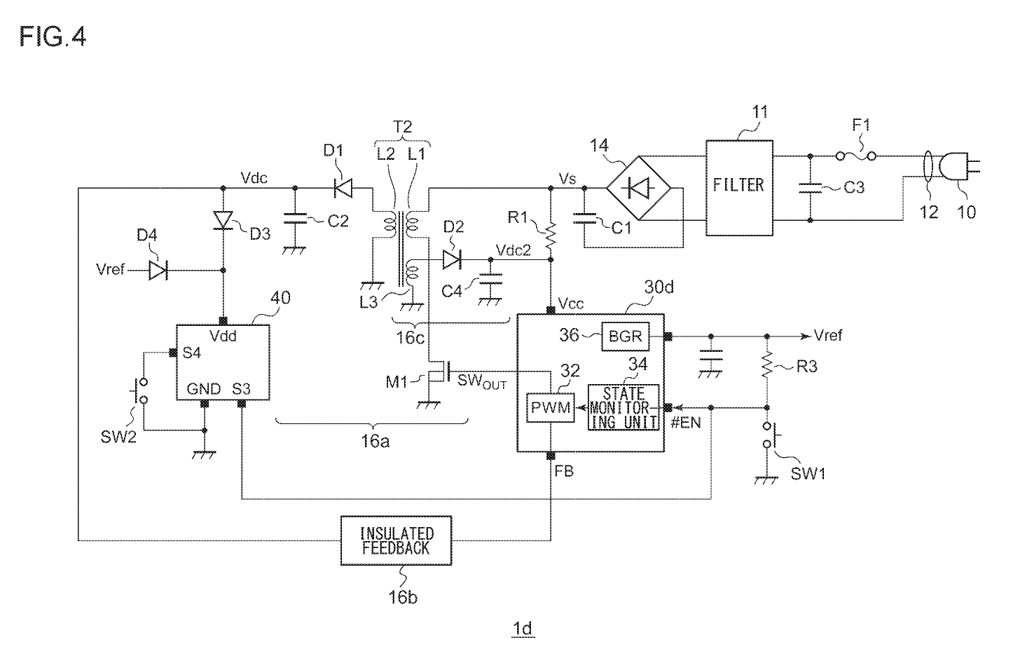

FIG. 4 is a diagram which shows a configuration of an electronic device according to a second embodiment.

An electronic device 1d includes a plug 10, a plug cable 12, a fuse F1, an input capacitor C3, a filter 11, a rectifier circuit 14, a DC/DC converter 16, a control IC 30, a microcomputer 40, an activation switch SW1, and a standby switch SW2. The electronic device 1d also includes other unshown circuit blocks. However, description thereof will be omitted.

The fuse F1 is arranged in order to protect the circuit from overvoltage or overcurrent. The filter 11 removes the high-frequency component of the AC voltage Vac.

The control IC 30d includes a switching signal generating unit 32, a state monitoring unit 34, and a BGR (Band Gap Regulator) 36. The control IC 30d receives, via its power supply terminal Vcc, the voltage Vs smoothed by the rectifier circuit 14. The state monitoring unit 34 switches the operation of the control IC 30d between the operating state and the standby state based on the control signal S3 input to the enable terminal #EN (“#” represents the so-called active low state). FIG. 4 shows an arrangement in which, when the control signal S3 is high level, the control IC 30d is set to the standby state, and when the control signal S3 is low level, the control IC 30d is set to the operating state. The BGR 36 generates a predetermined reference voltage Vref regardless of whether the state is the operating state or the standby state. The reference voltage Vref is output to a circuit external to the control IC 30d.

The electronic device 1d is configured to be switchable between the normal operating mode in which it provides its primary function and the standby mode (sleep mode) that differs from the operating mode. For example, with the electronic device 1d as an air conditioner, the normal operating mode corresponds to a period in which it supplies warm air or cool air. On the other hand, the standby mode corresponds to a period in which it is in a standby state according to a timer control operation.

The electronic device 1d includes the standby switch SW2 which allows the mode to be switched from the normal operating mode to the standby mode. The standby switch SW2 is configured such that, when the user presses the switch SW2, it is in the conducting state, and otherwise it is disconnected. The standby switch SW2 is connected to a control terminal S4 of the microcomputer 40. The microcomputer 40 monitors the state of the control terminal S4, and detects an instruction from the user to switch the mode to the standby mode.

The microcomputer 40 generates the control signal S3 which indicates whether the electronic device 1d at a given stage is in the normal operating mode or in the standby mode. When the electronic device 1d is in the normal operating mode, the control signal S3 is set to low level, and when the electronic device 1d is in the standby mode, the control signal S3 is set to high level. In the normal operating mode, the microcomputer 40 fixes the control terminal S3 at low level. Conversely, in the standby mode, the microcomputer 40 sets the terminal S3 to an open (high impedance) state. In this state, the control signal S3 is pulled up by a pull-up resistor R3, and accordingly, the control signal S3 is set to high level.

A coil L3, a switching transistor M1, a rectifier diode D2, and a capacitor C4 form a DC/DC converter 16c. The voltage Vdc2 generated by the DC/DC converter 16c, in addition to the smoothed voltage Vs, is supplied to the power supply terminal Vcc of the control IC 30d. That is to say, when the switching signal generating unit 32 is set to the operating state, the voltage Vdc generated by the DC/DC converter 16c is supplied to the power supply terminal Vcc. When the switching signal generating unit 32 is set to the standby state, the smoothed voltage Vs is supplied to the power supply terminal Vcc via the resistor R1.

The output voltage Vdc of the DC/DC converter 16 is supplied to the power supply terminal Vdd of the microcomputer 40 via a diode D3. Furthermore, the reference voltage Vref is supplied to the power supply terminal Vdd via a diode D4. That is to say, when the DC/DC converter 16 is in the operating state, the microcomputer 40 operates using the voltage Vdc from the microcomputer 40, and when the DC/DC converter 16 is in the non-operating state, the microcomputer 40 operates using the reference voltage Vref supplied from the control IC 30d.

The activation switch SW1 is provided in order to permit the control IC 30d in the standby state to be switched to the operating state. The activation switch SW1 is turned on by the user at a timing when the mode is to be switched from the standby mode to the normal operating mode. For example, the activation switch SW1 may be configured as a power supply switch of the electronic device 1.

The control IC 30d monitors the state of the activation switch SW1, and detects an instruction from the user to switch the mode. Upon detecting an instruction to switch the mode, the control IC 30d transits to the operating state. Specifically, the activation switch SW1 is arranged between the enable terminal EN of the control IC 30d and the ground terminal. When the activation switch SW1 is turned on, the enable terminal EN is pulled down, which sets the control signal S3 to low level. As a result, the control IC 30d is switched to the operating state.

The above is the configuration of the electronic device 1d. Next, description will be made regarding the operation of the electronic device 1d.

1. When the plug 10 is plugged into a receptacle, the smoothed voltage Vs is generated. Upon receiving the voltage Vs, the control IC 30d is started up, and the reference voltage Vref is generated by the BGR 36. After the reference voltage Vref is generated, the control signal S3 input to the enable terminal #EN is set to high level by means of the pull-up resistor R3, which sets the control IC 30d to the non-operating state.

2. Subsequently, the user presses the activation switch SW1. As a result, the control signal S3 is set to low level, which sets the control IC 30d to the operating state. In this state, the DC voltage Vdc is generated by the DC/DC converter 16, and is supplied to the power supply terminal Vdd of the microcomputer 40. When the supply of the DC voltage Vdc is received, the microcomputer 40 is started up, and the control signal S3 is fixed at the low level by the microcomputer 40.

3. Subsequently, the electronic device 1d is set to the normal operating state.

4. When the standby switch SW2 is turned on in the normal operating mode, the microcomputer 40 sets the control signal S3 to high level. As a result, the control IC 30d transits to the standby state.

The above is the operation of the electronic device 1d. With such an electronic device 1d, such an arrangement is capable of setting the control IC 30d of the DC/DC converter 16 to the standby state during the period in which the electronic device 1 is in the standby mode. Thus, such an arrangement is capable of reducing the standby power consumption to substantially zero.

In the standby mode, the DC voltage Vdc is not supplied to the power supply terminal Vdd of the microcomputer 40, but the reference voltage Vref is continuously supplied. Thus, such an arrangement allows the microcomputer 40 to perform the necessary minimum signal processing.

### Third Embodiment

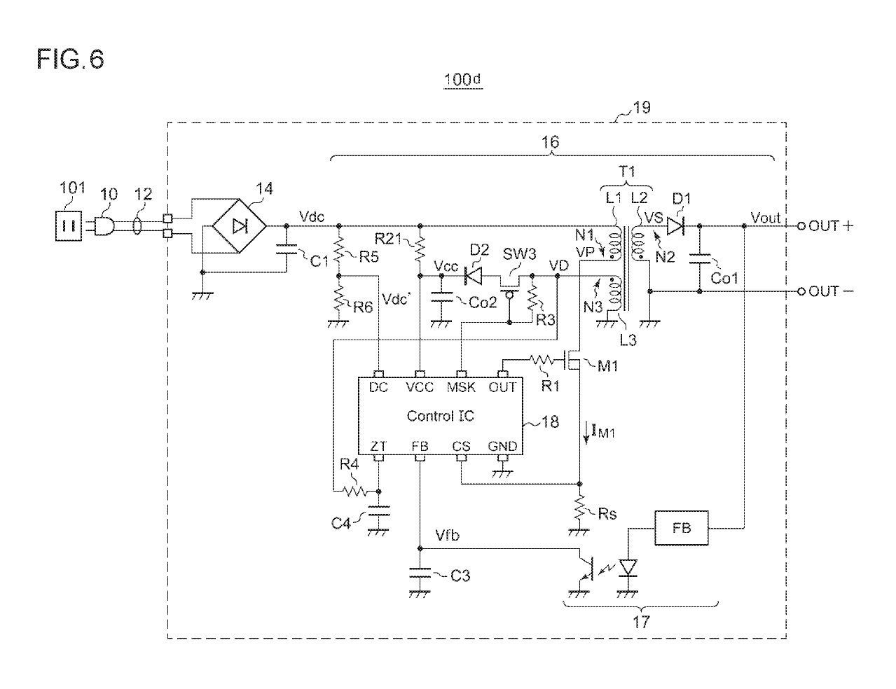

FIG. 6 is a circuit diagram which shows a configuration of a power supply apparatus 100d according to a third embodiment.

The power supply apparatus 100d is a power supply adapter configured to receive an AC voltage Vac such as commercial AC voltage or the like, to convert the AC voltage Vac thus received into a DC voltage Vdc, and to supply the DC voltage Vdc thus converted to an electronic device (not shown). Examples of such an electronic device 1 include a laptop computer, a desktop computer, a cellular phone terminal, a CD player, etc. However, the electronic device 1 is not restricted in particular.

The power supply adapter 100d includes a plug 10, a plug cable 12, a rectifier circuit 14, an input capacitor (smoothing capacitor) C1, and a DC/DC converter 16. The rectifier circuit 14, the input capacitor C1, and the DC/DC converter 16 are included within the same casing 19. The connection between the plug 10 and the casing 19 is provided by the plug cable 12.

The plug 10 is configured as a socket configured to engage with a receptacle, and is configured to receive the AC voltage Vac in the state in which it is plugged into a receptacle 101. The rectifier circuit 14 performs full-wave rectification of the AC voltage Vac supplied via the plug 10 and the plug cable 12. The rectifier circuit 14 is configured as a diode bridge circuit, for example. The smoothing capacitor C1 smoothes the voltage rectified by the rectifier circuit 14.

The DC/DC converter 16 according to the present embodiment receives the voltage Vdc smoothed by the input capacitor C1, and converts the voltage Vdc thus received into a DC voltage Vout having a level to be supplied to the electronic device.

The DC/DC converter 16 mainly includes a transformer T1, a first output capacitor Co1, a second output capacitor Co2, a first diode D1, a second diode D2, a switching transistor M1, a mask switch SW3, a feedback circuit 17, and a control circuit 18.

The transformer T1 includes a primary coil L1, a secondary coil L2, and an auxiliary coil L3 provided on the primary coil side. Description will be made with the number of windings of the primary coil L1 as NP, the number of windings of the secondary coil L2 as NS, and the number of windings of the auxiliary coil L3 as ND.

The switching transistor M1, the primary coil L1, the secondary coil L2, the first diode D1, and the first output capacitor Co1 form a first converter (main converter). The first output capacitor Co1 is arranged such that one terminal thereof is set to a fixed electric potential. The first diode D1 is arranged between the other terminal of the first output capacitor Co1 and one terminal N2 of the secondary coil L2 such that the cathode thereof is on the first output capacitor Co1 side. The other terminal of the secondary coil L2 is grounded, and is set to a fixed electric potential.

The switching transistor M1 is arranged on a path of the primary coil L1. A switching signal OUT output from the control circuit 18 is input to the gate of the switching transistor M1 via the resistor R1.

The switching transistor M1, the primary coil L1, the auxiliary coil L3, the second diode D2, and the second output capacitor Co2 form a second converter (auxiliary converter).

One terminal of the second output capacitor Co2 is set to a fixed electronic potential. The second diode D2 and the mask switch SW3 are arranged in series between the other terminal of the second output capacitor Co2 and one terminal N3 of the auxiliary coil L3. The other terminal of the auxiliary coil L3 is set to a fixed electric potential. The second diode D2 is arranged such that the cathode thereof is on the second output capacitor Co2 side. A second voltage Vcc develops at the second output capacitor Co2 according to the duty ratio of the switching transistor M1 and the winding ratio of the transformer T1.

The control circuit 18 receives, via its power supply terminal VCC, the second voltage Vcc that develops at the second output capacitor Co2. It should be noted that, in a period before the normal operation of the second converter, the DC voltage Vdc is supplied to the power supply terminal VCC of the control circuit 18 via a resistor R21.

The input voltage Vdc′ divided by the resistors R5 and R6 is input to the input terminal DC of the control circuit 18. The start-up and stop operations are controlled according to the input voltage Vdc′.

The control circuit 18 adjusts the duty ratio of the switching signal OUT by means of pulse width modulation (PWM), pulse frequency modulation (PFM), or the like, such that the level of the voltage Vout that develops at the first output capacitor Co1 approaches the target value, thereby controlling the switching transistor M1. The method for generating the switching signal OUT is not restricted in particular.

Furthermore, the control circuit 18 generates a mask signal MSK that is synchronized to the switching signal OUT, so as to control the mask switch SW3. The control circuit 18 turns off the mask switch SW3 during at least a predetermined period (which will be referred to as the “mask period ΔT”) after the switching transistor M1 is turned off. The control circuit 18 may turn off the mask switch SW3 during the on period Ton of the switching transistor M1 in addition to the mask period ΔT.

For example, the mask switch SW3 is configured as a P-channel MOSFET, which is arranged such that a third resistor R3 is arranged between the gate and the source thereof. The control circuit 18 sets the terminal MSK to a high-impedance (open) state during the on period Ton of the switching transistor M1 and the mask period ΔT. In this state, the gate and the source of the mask switch SW3 are shorted via the resistor R3, and accordingly, the mask switch SW3 is turned off. In the off period Toff of the switching transistor M1, after the mask period ΔT has elapsed, the control circuit 18 sets the mask signal MSK to low level, which turns on the mask switch SW3.

For example, the control circuit 18 generates the switching signal OUT and the mask signal MSK according to the output voltage Vout that develops at the first output capacitor Co1, a current IM1 that flows through the switching transistor M1 (primary coil L1), and a voltage VD that develops at the one terminal N3 of the auxiliary coil L3.

A feedback signal Vfb that corresponds to the output voltage Vout is input to a feedback terminal FB of the control circuit 18 via the feedback circuit 17 including a photo-coupler. The capacitor C3 is arranged in order to provide phase compensation. Furthermore, a detection resistor Rs is arranged in order to detect the current IM1 that flows through the switching transistor M1. The voltage drop (detection signal) Vs that occurs at the detection resistor Rs is input to a current detection terminal (CS terminal) of the control circuit 18. Furthermore, the voltage VD that develops at one terminal of the auxiliary coil L3 provided for the control circuit 18 is input to an ZT terminal via a low-pass filter including a resistor R4 and a capacitor C4.

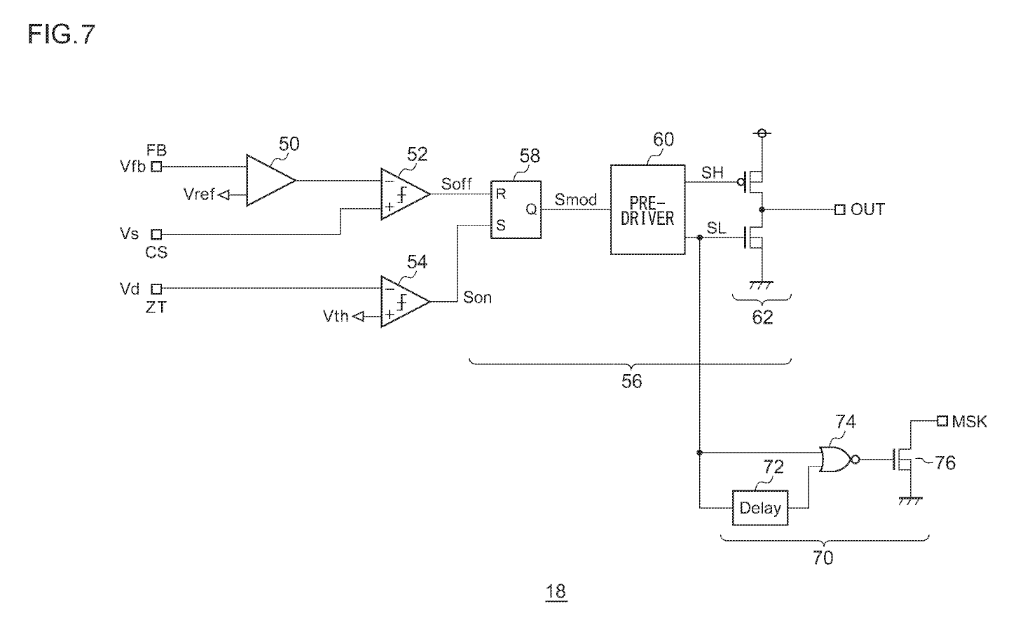

FIG. 7 is a circuit diagram which shows an example configuration of the control circuit shown in FIG. 6. The control circuit 18 includes an error amplifier 50, an off signal generating unit 52, an on signal generating unit 54, a driving unit 56, and a driver 62.

The error amplifier 50 amplifies the difference between the feedback signal Vfb and the reference voltage Vref that corresponds to the target value thereof. The off signal generating unit 52 includes a comparator configured to compare the detection signal Vs with an output signal of the error amplifier 50, and generates an off signal Soff which defines a timing at which the switching transistor M1 is to be turned off. When the current IM1 that flows through the switching transistor M1 reaches a level that corresponds to the output signal of the error amplifier 50, the off signal Soff thus generated by the off signal generating unit 52 is asserted.

For example, when the feedback signal Vfb is lower than the reference voltage Vref, the output signal of the error amplifier 50 is raised. This delays the timing at which the off signal Soff is asserted, which increases the on period Ton of the switching transistor M1. As a result, the feedback operation is performed so as to raise the output voltage Vout (feedback signal Vfb). Conversely, when the feedback signal Vfb is higher than the reference voltage Vref, the output signal of the error amplifier 50 is lowered, which advances the timing at which the off signal Soff is asserted. This reduces the on period Ton of the switching transistor M1. As a result, the feedback operation is performed so as to reduce the output voltage Vout (feedback signal Vfb).

The on signal generating unit 54 generates an on signal Son which is asserted after the off signal Soff is asserted. The on signal generating unit 54 shown in FIG. 7 includes a comparator configured to compare the electric potential Vd at the node N3 on a path between the second diode D2 and the auxiliary coil L3 with a predetermined level Vth. When the electric potential at the node N1 drops to the predetermined level Vth, the on signal generating unit 54 asserts the on signal Son.

When the switching transistor M1 is turned on, the current IM1 flows through the primary coil L1, thereby storing energy in the transformer T1. Subsequently, when the switching transistor M1 is turned off, the energy stored in the transformer T1 is discharged. The on signal generating unit 54 is capable of detecting whether or not the energy stored in the transformer T1 is completely discharged, by monitoring the voltage Vd that develops at the auxiliary coil L3. Upon detecting that the energy is discharged, the on signal generating unit 54 asserts the on signal Son so as to turn on the transistor M1 again.

When the on signal Son is asserted, the driving unit 56 turns on the switching transistor M1, and when the off signal Soff is asserted, the driving unit 56 turns off the switching transistor M1. The driving unit 56 includes a flip-flop 58, a pre-driver 60, and a driver 62. The flip-flop 58 receives the on signal Son and the off signal Soff via its set terminal and reset terminal, respectively. The state transition of the flip-flop 58 occurs according to the on signal Son and the off signal Soff. As a result, the duty ratio of the output signal Smod of the flip-flop 58 is modulated such that the feedback signal Vfb (output voltage Vout) matches the target value Vref. In FIG. 7, the high level of the driving signal Smod and the high level of the switching signal OUT are each associated with the on state of the switching transistor M1, and their low levels are each associated with the off state of the switching transistor M1.

The pre-driver 60 drives the driver 62 according to the output signal Smod of the flip-flop 58. Dead time is applied between the output signals SH and SL of the pre-driver 60 so as to prevent the high-side transistor and the low-side transistor of the driver 62 from switching on at the same time. The driver 62 outputs a switching signal OUT.

A mask signal generating unit 70 generates a mask signal MSK that is synchronized to at least one of either the on signal Son or the off signal Soff. Specifically, the mask signal generating unit 70 includes a delay circuit 72, a logical gate 74, and an output transistor 76. The delay circuit 72 delays the low-side driving signal SL by the mask time ΔT. The logical gate (NOR) 74 generates the logical NOR of the undelayed low-side driving signal SL and the delayed signal, and outputs the logical NOR thus generated to the gate of the output transistor 76. The mask signal generating unit 70 has an open drain configuration.

The above is the configuration of the power supply apparatus 100d. Next, description will be made regarding the operation thereof.

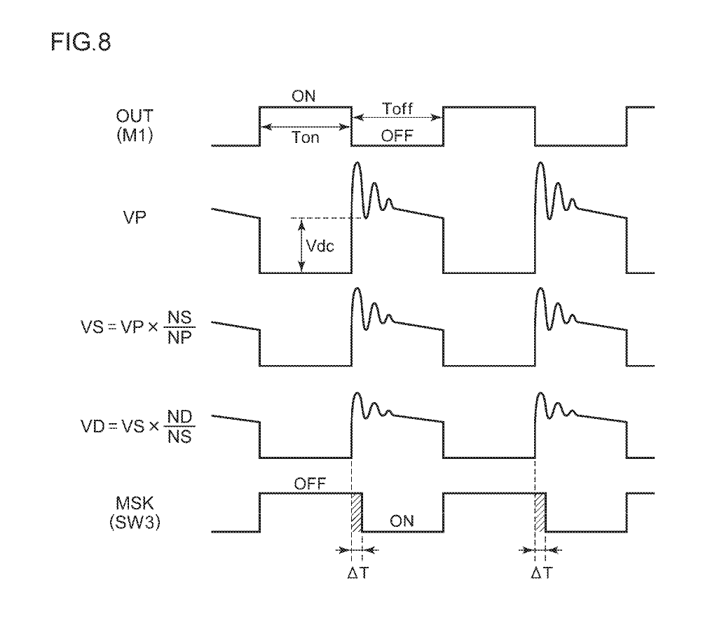

FIG. 8 is a time chart which shows the operation of the power supply apparatus 100d shown in FIG. 6. The vertical axis and the horizontal axis shown in FIG. 8 are expanded or reduced as appropriate for ease of understanding. Also, each waveform shown in the drawing is simplified for ease of understanding. FIG. 8 shows, in the following order from the top, the switching signal OUT, the electric potential VP at N1 which is one terminal of the primary coil L1, the electric potential VS at N2 which is one terminal of the secondary coil L2, the electric potential VD at N3 which is one terminal of the auxiliary coil L3, and the mask signal MSK.

First, directing attention to the main converter, the switching signal OUT is generated by the control circuit 18, and the switching transistor M1 alternately repeats the on state and the off state. During the on period of the switching transistor M1, the voltage VP is fixed in the vicinity of the ground voltage.

When the switching transistor M1 is turned off, back electromotive force occurs at the primary coil L1, which causes a large jump in the voltage VP. When Vdc=140 V, in some cases, the peak voltage reaches on the order of 280 V, which is double the input voltage Vdc. When the switching transistor M1 is turned off, the energy stored in the primary coil L1 is transferred to the first output capacitor Co1 via the first diode D1.

The voltage VS develops at one terminal of the secondary coil L2, and is proportional to the voltage VP of the primary coil L1, i.e., it has a steep peak. The aforementioned one terminal of the secondary coil L2 and the first output capacitor Co1 are coupled via the first diode D1. Accordingly, if the first output capacitor Co1 has a small capacitance, the output voltage Vout would follow the voltage VP, and the output voltage Vout would rise so as to satisfy the relation Vout=VP−Vf. Here, Vf represents the forward voltage of the first diode D1. However, the first output capacitor Co1 has a sufficiently large capacitance. Thus, there is almost no rise in the output voltage Vout. That is to say, the output voltage Vout is maintained at a constant level.

Next, description will be made directing attention to the auxiliary converter. Ripple noise occurs in the voltage VD that develops at the auxiliary coil L3, as it does in the voltage VP. As shown in FIG. 8, during the mask period ΔT after the switching transistor M1 is turned off, the mask signal MSK is set to high level, which turns off the mask switch SW3. The mask period ΔT is set such that it overlaps the period in which ripple noise occurs in the voltage VS.

During the mask period ΔT, the mask switch SW3 is turned off. Accordingly, ripple noise that occurs in the voltage VD is not applied to the second output capacitor Co2. Thus, such an arrangement is capable of suppressing the jump in the second voltage Vcc even if the second output capacitor Co2 has a small capacitance.

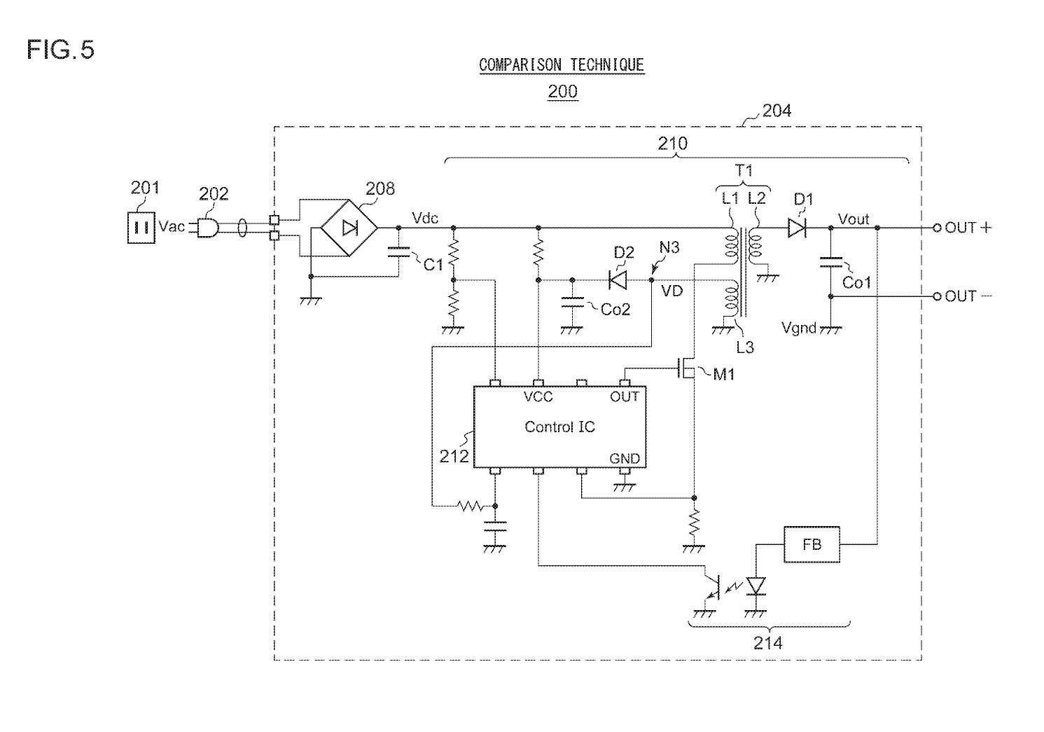

The advantage of the power supply apparatus 100d shown in FIG. 6 can be clearly understood by comparing it with the circuit shown in FIG. 5. If the auxiliary coil L3, the second diode D2, and the second output capacitor Co2 are directly connected as shown in FIG. 5, the ripple noise that occurs in the voltage VP also occurs in the second voltage Vcc. This is because the second output capacitor Co2 does not have a sufficiently large capacitance.

In a case in which ripple noise occurs in the second voltage Vcc, in some cases, the control circuit 18 performs unnecessary overvoltage protection (OVP). Accordingly, in this case, it is difficult to design the threshold voltage for the overvoltage protection. Alternatively, such an arrangement requires the control circuit 18 to have a high breakdown voltage, leading to high costs.

With the power supply apparatus 100d shown in FIG. 6, such an arrangement is capable of solving such a problem of the second voltage Vcc greatly rising. This allows the control circuit 18 to be easily designed. Alternatively, such an arrangement provides reduced costs.

Description will be made below regarding a very useful modification thereof, which is based on the advantage that no ripple noise occurs in the second voltage Vcc.

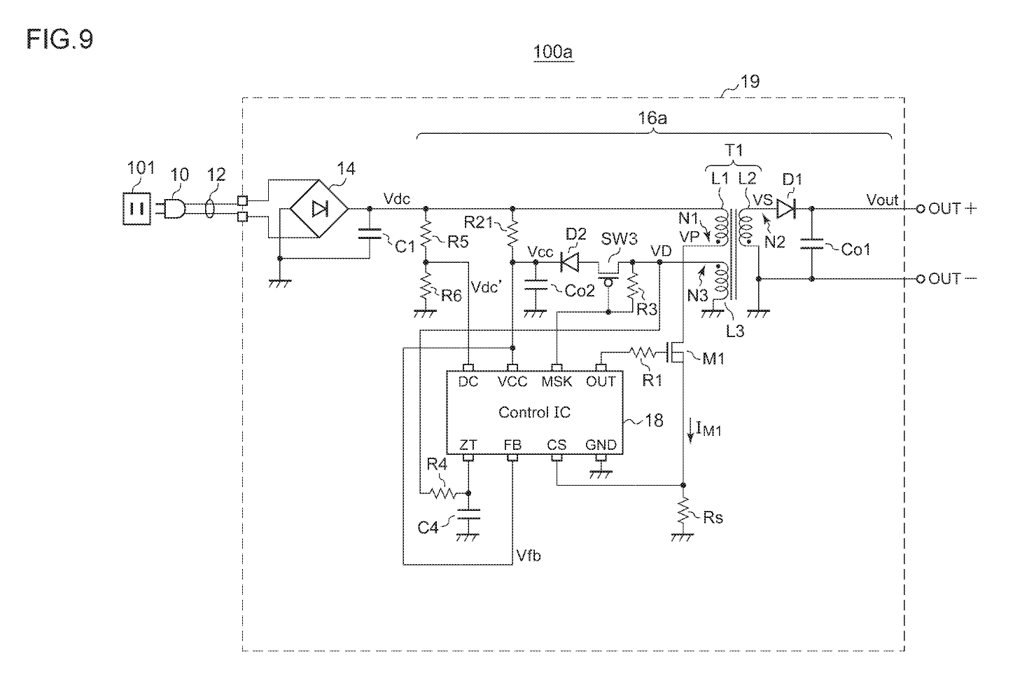

FIG. 9 is a circuit diagram which shows a configuration of a power supply apparatus 100a according to a modification.

With such an arrangement shown in FIG. 5, large ripple noise is applied to the second voltage Vcc. Accordingly, such an arrangement cannot perform a feedback operation based upon the second voltage Vcc. Thus, such an arrangement is configured to generate the switching signal OUT based upon the feedback signal Vfb that corresponds to the output voltage Vout.

In contrast, with the power supply apparatus 100a according to such a modification, the second voltage Vcc is stabilized. Accordingly, such an arrangement is configured to generate the switching signal OUT based on the second voltage Vcc. Specifically, a feedback signal Vfb that corresponds to the second voltage Vcc is fed back to the feedback terminal FB of the control circuit 18.

The second voltage Vcc develops on the primary side of the transformer T1. Thus, the second voltage Vcc can be electrically fed back to the control circuit 18. That is to say, such an arrangement does not require the aforementioned photo-coupler, thereby providing reduced costs.

The feedback terminal FB and the power supply terminal VCC each receive a signal that corresponds to the second voltage Vcc. Thus, such an arrangement may have a shared terminal for the feedback signal and the power supply signal, instead of the feedback terminal FB and the power supply terminal VCC. With such an arrangement, the control circuit 18 requires a reduced number of pins, thereby providing a reduced chip size.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

Description will be made regarding examples of modifications of the mask switch SW3.

For example, the mask switch SW3 may be configured as a PNP bipolar transistor, or may be configured as a transfer gate. Also, the positions of the mask switch SW3 and the second diode D2 may be exchanged.

Description has been made in the embodiment regarding an arrangement in which the mask period ΔT is fixed. Also, the length of the mask period ΔT may be dynamically controlled based on any one of the voltages VP, VS, or VD that respectively develop at the primary coil L1, the secondary coil L2, and the auxiliary coil L3.

The mask signal MSK may be generated by a circuit external to the control circuit 18.

In the on period Ton of the switching transistor M1, no current flows from the auxiliary coil L3 to the second output capacitor Co2. Thus, in the on period Ton, the mask switch SW3 may be turned off, or may be turned on. For generating the required mask signal MSK, various configurations of the mask signal generating unit 70 can be designed by those skilled in this art. For example, the mask signal generating unit 70 may generate the mask signal based on any one of the on signal Son, the off signal Soff, the modulation signal Smod, the high-side driving signal SH, or the low-side driving signal SL, or a combination of these signals. Also, the mask signal generating unit 70 may employ a one-shot circuit, a counter, or a timer, instead of or in addition to the delay circuit 72.

Also, various types of arrangements may be made with respect to the control circuit 18, and the configuration thereof is not limited by the present invention, which can be understood by those skilled in this art. Also, a commercially-available general purpose control circuit may be employed as the control circuit 18.

Also, a timer circuit configured to count a predetermined off period Toff may be employed as the on signal generating unit 54 shown in FIG. 7, instead of the aforementioned comparator. Also, the off period Toff may be fixed on the basis of a prior estimation of the period of time required to discharge the energy. Such an arrangement provides a simple circuit configuration, in a trade-off with deterioration in the energy efficiency.

Also, the technique according to the third embodiment represented by an arrangement shown in FIG. 6 can be suitably combined with the second embodiment represented by an arrangement shown in FIG. 4. That is to say, the circuit shown in FIG. 4 may include the mask switch SW3 configured to be controlled according to a mask signal.

Description has been made in the embodiment regarding an arrangement in which the DC/DC converter 16 is mounted on a power supply adapter. However, the present invention is not restricted to such an arrangement. Also, the present invention can be applied to various kinds of power supply apparatuses.

Description has been made regarding the present invention with reference to the embodiments using specific terms. However, the above-described embodiments show only the mechanisms and applications of the present invention for exemplary purposes only, and are by no means intended to be interpreted restrictively. Rather, various modifications and various changes in the layout can be made without departing from the spirit and scope of the present invention defined in appended claims.

1-10. (canceled)

11. An electronic device configured to operate receiving an AC voltage, and to be switchable between a normal operating mode and a standby mode, the electronic device comprising:
a plug configured to receive the AC voltage in a state in which it is plugged into a receptacle;
a rectifier circuit configured to rectify the AC voltage supplied via the plug;
a smoothing capacitor configured to smooth the voltage rectified by the rectifier circuit;
a DC/DC converter configured to receive the voltage smoothed by the smoothing capacitor, and to convert the voltage thus smoothed into a DC voltage having a predetermined level;
a control circuit configured to receive the smoothed voltage via a power supply terminal thereof, to control the DC/DC converter such that the output voltage of the DC/DC converter is maintained at a constant level, and to be switchable between an operating state and a non-operating state according to a control signal input to an enable terminal thereof;
an activation switch configured to receive an instruction to switch the mode of the electronic device from the standby mode to the normal operating mode;
a standby switch configured to receive an instruction to switch the mode of the electronic device from the normal operating mode to the standby mode; and
a signal processing unit configured to receive the output voltage of the DC/DC converter via a power supply terminal thereof, to perform predetermined signal processing when the electronic device is in the normal operating mode, to monitor the standby switch, and to output, to the enable terminal of the control circuit, a control signal which indicates whether or not the electronic device is in the normal operating mode or in the standby mode.

12. The electronic device according to claim 11, wherein the control circuit comprises:
a reference voltage circuit configured to generate a predetermined reference voltage; and
a reference voltage terminal configured to output the reference voltage to an external circuit,
wherein, together with the output voltage of the DC/DC converter, the reference voltage is supplied to the power supply terminal of the signal processing unit.

13-23. (canceled)
